(19) United States
(12) Patent Application Publication
(10) Pub. No.: US 2012/0259535 A1
(43) Pub. Date: Oct. 11, 2012

(54) Method and device for improving the restart of a vehicle with start-stop system

(76) Inventors: Rolf Jaros, Backnang (DE); Julian Roesner, Untergruppenbach (DE)

(21) Appl. No.: 13/501,575

(22) PCT Filed: Aug. 31, 2010
(86) PCT No.: PCT/EP10/62712

§ 371 Date: Jun. 26, 2012

(30) Foreign Application Priority Data
Oct. 21, 2009 (DE) 10 2009 045 886.7

(51) Int. Cl. F02D 28/00

(52) U.S. Cl. 701/113

(57) ABSTRACT

A method and a device for improving the restart of a vehicle equipped with start-stop operation. In order to accelerate the restart, in a stop phase of the start-stop operation a control unit provides control signals on the basis of which the excitation winding is supplied with a pre-excitation current in the stop phase. In addition, given the presence of a restart request occurring during the slowdown of the internal combustion engine, the control unit checks whether an immediate restart is possible and sensible, and, in the case in which an immediate restart is possible and sensible, initiates an immediate restart, and delays the restart in the case in which an immediate restart is not possible or not sensible.

### FIELD OF THE INVENTION

The present invention relates to a method and to a device for improving the restarting of a vehicle equipped with start-stop operation.

### BACKGROUND INFORMATION

Systems for stopping and restarting internal combustion engines, in particular for the purpose of reducing fuel consumption and exhaust gas emissions, are known under the designation start-stop system.

From EP 1 469 587 B1, a device is discussed for improving the start-stop operation of a vehicle. This device has an excitation winding allocated to the starter generator of the vehicle and connected to the vehicle electrical system, and also has a control unit. The control signals supplied by the control unit influence the excitation current flowing through the excitation winding. In the stop phase of the start-stop operation, the control unit provides control signals on the basis of which the excitation winding is supplied with a pre-excitation current in the stop phase.

From DE 10 2006 057 892 A1, a method is discussed for the pre-magnetization of an electric machine for an automatic start of an internal combustion engine of a motor vehicle having an automated start-stop system. Here, starting from a stop phase of the internal combustion engine introduced by an automatic engine stop, the electric machine is pre-magnetized within this stop phase and before the presence of a start request for an automatic engine start. At least one of the following parameters is variable: starting time of the pre-magnetization, magnitude of the pre-magnetization current, and time duration for which a magnetization current is activated.

From WO 2009/024724 A1, a further method is discussed for stopping and restarting a motor vehicle. Here, first the internal combustion engine is stopped, an excitation current is maintained for a predetermined period of time, and at the end of the predetermined period of time the excitation current is shut off.

### SUMMARY OF THE INVENTION

In contrast, a method for improving the restart of a vehicle equipped with start-stop operation having the features described herein has the advantage that in the case of a restart request occurring during the slowdown of the internal combustion engine, the time span until restart is kept as small as possible, ensuring that material loads are reduced and destruction of material is avoided.

This holds in particular when a two-mass flywheel is situated on the crankshaft of the internal combustion engine. In this case, using a method according to the present invention disturbing noise and vibrations caused by resonance effects of the two-mass flywheel are reduced or are completely avoided. This also reduces costs, because the two-mass flywheel is relieved of stress and can accordingly be dimensioned more economically.

In addition, a reduction of fuel consumption and a reduction of exhaust gas emissions are achieved. Start-stop operation can be used more often than in the existing art.

In addition, the safety of street traffic is improved, because in the case of a restart request occurring already during the slowdown of the internal combustion engine, the internal combustion engine can be restarted more quickly. This reduces the time span within which the vehicle cannot be moved out of a danger zone. In addition, customer acceptance of start-stop systems is improved. In particular, the exemplary embodiments and/or exemplary methods of the present invention result in a reproducible start behavior.

Further advantageous characteristics of the exemplary embodiments and/or exemplary methods of the present invention result from the explanation given below on the basis of the drawings.

### BRIEF DESCRIPTION OF THE DRAWINGS

FIG. 1 shows a flow diagram for the explanation of a method for improving the restart of a vehicle equipped with start-stop operation.

FIG. 2 shows a block diagram of a device for improving the restart of a vehicle equipped with start-stop operation.

### DETAILED DESCRIPTION

The exemplary embodiments and/or exemplary methods of the present invention relate to a method for improving the restart of a vehicle equipped with start-stop operation, having an excitation winding allocated to the starter generator of the vehicle, and having a control unit whose control signals influence the excitation current flowing through the excitation winding, and in which during a stop phase of the start-stop operation the control unit provides control signals on the basis of which the excitation winding is supplied with a pre-excitation current in the stop phase, the control unit checking, given the presence of a restart request occurring during the slowdown of the internal combustion engine, whether an immediate restart is possible and sensible, and initiating an immediate restart in the case in which an immediate restart is possible and sensible, and delaying the restart in the case in which an immediate restart is not possible and/or not sensible.

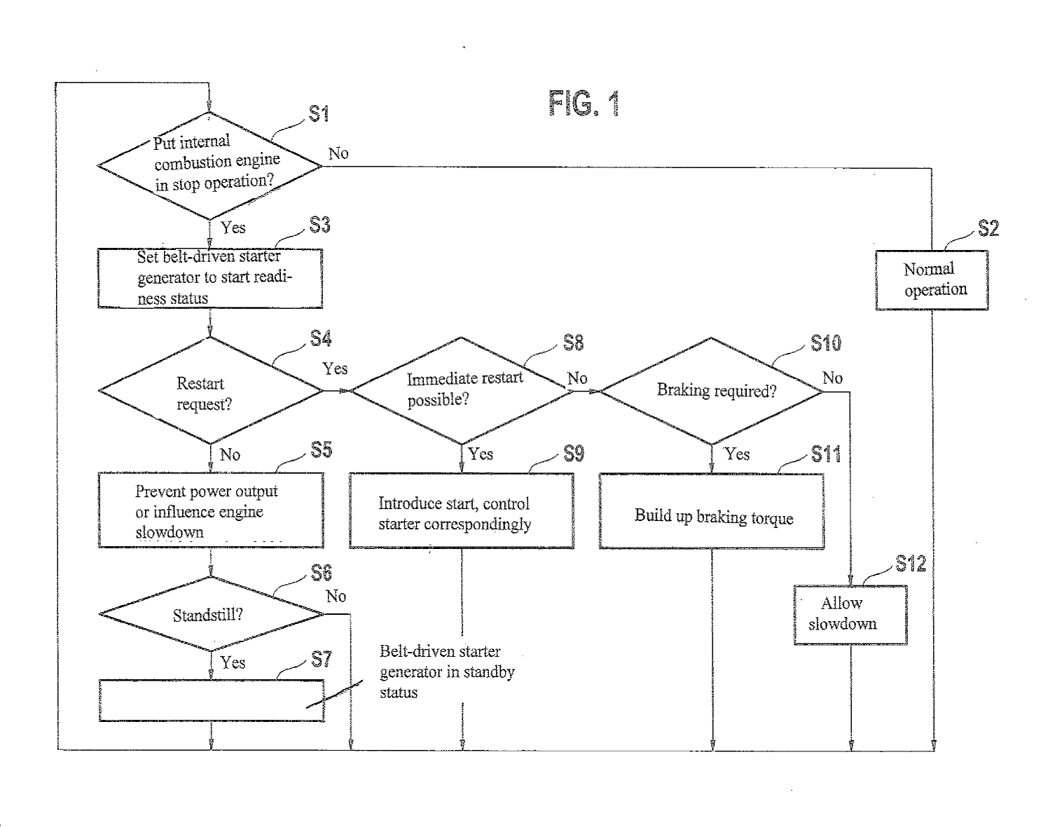

FIG. 1 shows a flow diagram explaining a method for improving the restart of a vehicle equipped with start-stop operation.

The depicted method proceeds from the assumption that the internal combustion engine of the vehicle is in operation.

According to the depicted method, in a step S1 a query is made as to whether a request is present to go into stop operation. This request comes from a control device (not shown in FIG. 1), and is automatically produced for example at a stoplight when specified stop conditions are met. These include for example falling below a specified speed limit with simultaneous actuation of the vehicle brake.

If no request to go into stop operation is present, then in a following step S2 normal operation of the vehicle is continued.

If, on the other hand, a request to go into stop operation is present, then the method moves to a step S3. In step S3, the starter generator of the vehicle, which is a belt-driven starter generator or a directly attached starter generator, is brought into start readiness status. This start readiness status enables a rapid buildup of torque in the case of a restart request occurring during the slowdown of the internal combustion engine. For this purpose, the excitation current is switched on. A complete excitation is possible but not required. Consequently, a partial excitation may be set. This partial excitation may be variable as a function of the momentary operating state of the vehicle.

If, according to step S3, the starter generator is prepared for an output of torque, in a step S4 a query is then made as to whether a restart request is present. Such a restart request is for example triggered by an actuation of the gas pedal.

If no restart request is present, then in a step S5 it is ensured that the starter generator whose excitation winding is supplied with an excitation current is outputting neither an undesirably high electric power nor an undesirably high mechanical power. This takes place through a corresponding controlling of the stator of the starter generator, for example through a field-oriented regulation or, in block-commutated systems, through a pre-commutation. Here, the starter generator is actively controlled for the purpose of influencing the slowdown behavior via a controlled output of torque. In this way, the slowdown of the internal combustion engine is controlled either in driving fashion or in braking fashion, for example for the purpose of achieving a gentle slowdown or for the purpose of positioning the crankshaft in a desired angular position.

Alternatively to an active controlling, a passive behavior of the starter generator can also be brought about by controlling the stator of the starter generator in such a way that the starter generator behaves as neutrally as possible at its mechanical interface.

In a following step S6, a query is made as to whether the starter generator has come to a standstill. If this is the case, then according to a step S7 the starter generator is held in the start readiness status, by ensuring that an excitation current remains present in order to accelerate a restart that may occur. The magnitude of the excitation current can be smaller than the maximum. A variable setting of this excitation current may takes place as a function of the momentary operating state of the internal combustion engine.

If the query in step S4 yields the result that a restart request is present, in a step S8 a query is then made as to whether an immediate restart is possible and sensible. As a criterion for whether an immediate restart is possible and sensible, it is checked whether the momentary rotational speed of the internal combustion engine is within a specified rotational speed range. Alternatively or in addition to this, it is checked whether the crankshaft angle is within a specified angular range. Alternatively or in addition to this, the momentary state of the vehicle electrical system and the type and operating behavior of the internal combustion engine are used as a criterion for whether an immediate restart is possible and sensible.

A restart that is not possible and not sensible is for example recognized when the momentary rotational speed of the internal combustion engine is in the range of the resonant frequency of the two-mass flywheel situated on the crankshaft.

A possible and sensible immediate restart is for example recognized when the momentary crankshaft angle is such that the compression work can be used and the momentary rotational speed of the internal combustion engine is in a desired rotational speed range.

A possible and sensible immediate restart is for example also recognized when particular operating states are present of the internal combustion engine or of the vehicle drivetrain. For example, the system can wait until a throttle valve or some other actuator on the internal combustion engine is set in such a way that a favorable condition for a restart is present.

If, in the query in step S8, it is recognized that an immediate restart is possible and sensible, then in a step S9 the restart is introduced by correspondingly controlling the starter. Because the excitation current is already activated and provides rotor electric loading, only a corresponding controlling of the stator is required. Because the time constant of the stator is low, this procedure achieves a significant savings of time during restart.

If, on the other hand, the query in step S8 yields the recognition that an immediate restart is not possible or not sensible, there then takes place, in a step S10, a query as to whether a braking of the internal combustion engine is required, which may be with the assistance of a braking torque built up by the starter generator. This is for example the case when the rotational speed of the internal combustion engine is still greater than a specified rotational speed threshold value.

If in the query in step S10 it is recognized that a braking is required, then according to a step S11 the required braking torque is built up.

If on the other hand in the query in step S10 it is recognized that a braking is not required, then a step S12 ensures that the internal combustion engine slows down. During this slowdown, the control unit brings it about that the starter generator, whose excitation winding is supplied with an excitation current, outputs or receives neither an undesirably high electrical power nor an undesirably high mechanical power. This takes place through a corresponding controlling of the stator of the starter generator, for example through a field-oriented regulation or, in block commutated systems, through a pre-commutation. Here, the starter generator is actively controlled for the purpose of influencing the slowdown behavior by a controlled output of torque. In this way, the slowdown of the internal combustion engine is controlled either in driving fashion or in braking fashion, for example for the purpose of a gentle slowdown or for the purpose of positioning the crankshaft in a desired angular position.

After carrying out steps S2, S7, S9, S11, and S12, the method jumps back to step S1. A jump to step S1 takes place even if in the query in step S6 it is recognized that the starter generator has not come to a standstill.

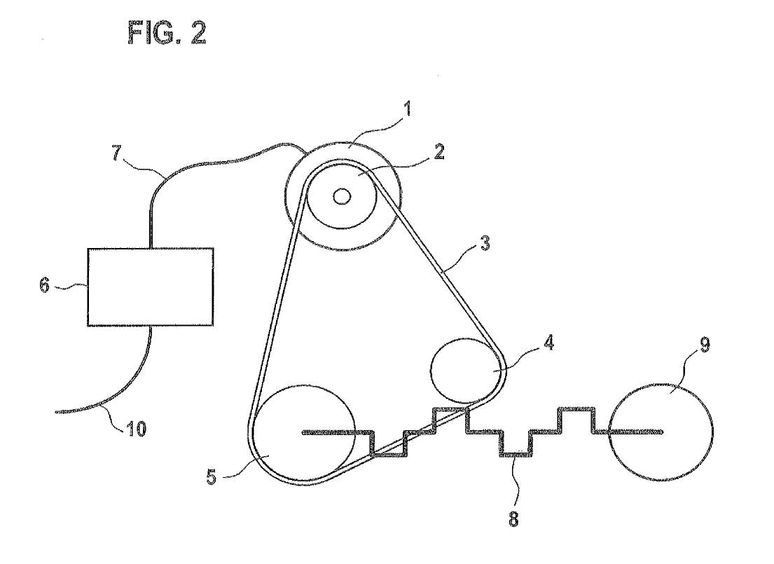

The carrying out of the method described above requires a control unit fashioned for carrying out the method described above. As is shown below on the basis of FIG. 2, this control unit is connected to other control devices and to sensors of the vehicle via a communication line, and is connected to the starter generator of the vehicle via a further line.

FIG. 2 shows a block diagram of a device for improving the restart of a vehicle equipped with start-stop operation.

The depicted device has a belt-driven starter generator 1, a belt pulley 2 connected thereto, a drive belt 3, a deflecting and tension roller 4, a belt pulley 5 situated on a crankshaft of the vehicle, a control unit 6, a line 7, a crankshaft 8, a two-mass flywheel 9, and a communication line 10. Control unit 6 is provided for controlling the method described on the basis of FIG. 1.

Starter generator 1 is connected to crankshaft 8 of the internal combustion engine of the vehicle via a belt drive to which there appertain belt pulley 2, drive belt 3, deflecting and tension roller 4, and belt pulley 5. A flywheel 9, which may be a two-mass flywheel, is attached to crankshaft 6. With such a device it is possible to transmit mechanical power between the crankshaft and the starter generator.

Control unit 6 is connected electrically to starter generator 1 via line 7. It can also be integrated in starter generator 1. The power-side controlling of the starter generator is realized using this control unit 6. For this purpose, control unit 6 has a pulse-controlled inverter constructed from semiconductor switches, and has a logic part.

Control unit 6 is connected to other control devices and to sensors of the vehicle via communication line 10, and exchanges data with these devices and sensors. For example, control unit 6 communicates with an engine control device, a transmission control device, a vehicle electrical system control device, and with sensors for acquiring the crankshaft angle and the battery state.

Alternatively to the exemplary embodiment shown in FIG. 2, the starter generator can also be attached directly on the internal combustion engine or on the transmission of the motor vehicle. The starter generator is connected to the internal combustion engine or to the transmission by a chain, a shaft, or a gear.

According to all of this, the exemplary embodiments and/or exemplary methods of the present invention enable a rapid restart when a restart request is present already during the slowing down of the internal combustion engine. The driver of the motor vehicle can count on the fact that the internal combustion engine will always be available. This is achieved in that the starter can accelerate the internal combustion engine by supplying torque before the internal combustion engine has come to a standstill. This ensures that no operating states occur that would disturb operation or even cause material damage.

This holds in particular given the use of a two-mass flywheel connected to the crankshaft. Two-mass flywheels are inherently liable to a resonant frequency, because they form a two-mass torsional oscillator. This resonant frequency is standardly above the rotational speed at which an internal combustion engine is first ignited, but is below the idling rotational speed of the internal combustion engine. Thus, the resonance range is run through both during starting and also when the internal combustion engine is shut off. When the crankshaft rotational speed remains for some time in the resonance range, this causes clearly detectable vibrations of the internal combustion engine. Damage to components, up to and including destruction of these components, cannot be excluded. Such operating states, in which damage or even destruction of the components can occur, are avoided in the procedure according to the exemplary embodiments and/or exemplary methods of the present invention.

1-12. (canceled)

13. A method for improving a restart of a vehicle equipped with start-stop operation, having an excitation winding allocated to the starter generator of the vehicle and having a control unit, the method comprising:
providing control signals from the control unit to influence the excitation current flowing through the excitation winding, and in which, in a stop phase of the start-stop operation, wherein the control unit provides control signals on the basis of which the excitation winding is supplied with a pre-excitation current in the stop phase; and
given the presence of a restart request occurring during the slowdown of the internal combustion engine, checking, using the control unit, whether an immediate restart is possible and sensible, and if so, initiating an immediate restart, and if not, delaying the restart.

14. The method of claim 13, wherein given the presence of a restart request occurring during the slowdown of the internal combustion engine, the control unit checks whether the momentary rotational speed of the internal combustion engine is in the range of the resonant frequency of a flywheel situated on the crankshaft of the internal combustion engine, and if so the restart is delayed.

15. The method of claim 13, wherein if an immediate restart is not possible, the control unit initiates a braking of the internal combustion engine.

16. The method of claim 13, wherein if an immediate restart of the internal combustion engine is not possible or not sensible, the control unit allows the internal combustion engine to slow down, and controls the starter generator of the vehicle with the purpose of influencing the slowdown behavior of the internal combustion engine or with the purpose of bringing about a passive behavior of the starter generator.

17. The method of claim 13, wherein the control unit checks whether an immediate restart is possible and sensible by checking whether the momentary rotational speed of the internal combustion engine is in a specified rotational speed range.

18. The method of claim 13, wherein the control unit checks whether an immediate restart is possible and sensible by checking whether the crankshaft angle is in a specified angular range.

19. The method of claim 13, wherein the control unit checks whether an immediate restart is possible and sensible by checking whether an actuator of the vehicle is in a specified state.

20. The method of claim 13, wherein, in the case in which an immediate restart is possible and sensible, the control unit initiates the restart by controlling the stator of the starter generator.

21. The method of claim 13, wherein, when a restart request occurring during the slowdown of the internal combustion engine is not present, the control unit controls the starter generator for the purpose of influencing the slowdown behavior of the internal combustion engine or for the purpose of bringing about a passive behavior of the starter generator.

22. A device for improving a restart of a vehicle equipped with start-stop operation, comprising:
a starter generator having an excitation winding; and
a control unit connected to the starter generator via a line;
wherein the control unit is configured for improving the restart of the vehicle equipped with start-stop operation, having the excitation winding allocated to the starter generator of the vehicle and having the control unit, by performing the following:
providing control signals from the control unit to influence the excitation current flowing through the excitation winding, and in which, in a stop phase of the start-stop operation, wherein the control unit provides control signals on the basis of which the excitation winding is supplied with a pre-excitation current in the stop phase; and
given the presence of a restart request occurring during the slowdown of the internal combustion engine, checking, using the control unit, whether an immediate restart is possible and sensible, and if so, initiating an immediate restart, and if not, delaying the restart.

23. The device of claim 22, further comprising:
a belt pulley connected to the starter generator;
a crankshaft;
a belt pulley situated on the crankshaft; and
a drive belt positioned around the belt pulley of the starter generator and around the belt pulley on the crankshaft.

24. The device of claim 22, wherein the starter generator is connected to the internal combustion engine or to a transmission of the vehicle by one of a chain, a shaft, and a gear.
